(19) United States
(12) Patent Application Publication
(10) Pub. No.: US 2021/0164157 A1
(43) Pub. Date: Jun. 3, 2021

(54) FOAMED URETHANE SHEET AND SYNTHETIC LEATHER

(71) Applicant: DIC Corporation, Tokyo (JP)

(72) Inventor: Tomohiro TETSUI, Osaka (JP)

(21) Appl. No.: 16/761,684

(22) PCT Filed: Nov. 1, 2018
(86) PCT No.: PCT/JP2018/040669

§ 371 Date: May 5, 2020

(30) Foreign Application Priority Data
Nov. 15, 2017 (JP) 2017-219952
Nov. 15, 2017 (JP) 2017-219953
Dec. 1, 2017 (JP) 2017-231691
Dec. 5, 2017 (JP) 2017-233365

(51) Int. Cl. D06N 3/14; B32B 5/18; B32B 27/40

(52) U.S. Cl. CPC D06N 3/14; B32B 5/18; B32B 27/40; B32B 2250/02; B32B 2250/24; D06N 2203/068; B32B 2307/73; B32B 2307/72; D06N 2209/142; D06N 2205/04; B32B 2266/0278

(57) ABSTRACT

The present invention provides a foamed urethane sheet which is formed from an aqueous urethane resin composition containing a urethane resin (A), an aqueous medium (B), and a surfactant (C) having 10 or more carbon atoms, and has a density of 200 to 1,000 kg/m³. Further, the present invention provides a synthetic leather having at least a substrate (i) and a polyurethane layer (ii), wherein the polyurethane layer (ii) is formed from the foamed urethane sheet according to any one of claims 1 to 4. The polyurethane layer (ii) may be embossed. The surfactant (C) is preferably a stearic acid salt, and the urethane resin (A) which has an anionic group, and has a flow starting temperature of 80° C. or higher is preferably used.

### TECHNICAL FIELD

The present invention relates to a foamed urethane sheet.

### BACKGROUND ART

Polyurethane resins have excellent mechanical strength and flexibility, and have been used in various applications, such as a coating agent and an adhesive. Especially, a solvent urethane resin containing dimethylformamide (DMF) has been widely used, but the use of DMF is more and more strictly regulated, and there is a pressing need for the development of environment-friendly products of urethane resin, such as weak solvent, aqueous solvent, or solvent-less products.

Among such products, aqueous urethane (PUD) having a urethane resin dispersed in water is being most energetically studied. In the use of the aqueous urethane in various applications, there are many needs for forming a foamed material from the aqueous urethane for improving the texture and the like. With respect to the method for forming a foamed material from aqueous urethane, studies are made on, for example, a method of incorporating microcapsules into the aqueous urethane, and a mechanical foaming method of dispersing a gas, such as carbon dioxide, in a PUD blend (see, for example, PTL 1). However, the method of incorporating microcapsules has problems in that the obtained foamed material has poor texture, and in that expansion of the microcapsules causes poor smoothness. Further, in the method of dispersing a gas, the bubbles generated in the PUD blend, for example, disappear during the process of producing a foamed material, and hence it is difficult to control the size of bubbles and the like, making it difficult to stably obtain a foamed material having excellent texture.

### CITATION LIST

### Patent Literature

PTL 1: JP-A-2007-191810

### SUMMARY OF INVENTION

### Technical Problem

An object to be achieved by the present invention is to provide a foamed urethane sheet which uses a urethane resin composition containing water, and which has excellent texture and tensile strength.

### Solution to Problem

The present invention provides a foamed urethane sheet which is formed from a urethane resin composition containing a urethane resin (A), water (B), and a surfactant (C) having 10 or more carbon atoms, and has a density of 200 to 1,000 kg/m³.

Further, the invention provides a synthetic leather having at least a substrate (i) and a polyurethane layer (ii), wherein the polyurethane layer (ii) is formed from the above-mentioned foamed urethane sheet.

### Advantageous Effects of Invention

The foamed urethane sheet of the invention has excellent texture and tensile strength.

Further, when the foamed urethane sheet is applied to a synthetic leather, the obtained synthetic leather is advantageous not only in that it further has excellent peel strength, but also in that embossing having excellent design properties can be uniformly formed on the surface of the synthetic leather.

### DESCRIPTION OF EMBODIMENTS

The foamed urethane sheet of the present invention is formed from a urethane resin composition containing a urethane resin (A), water (B), and a surfactant (C) having no aromatic ring and having a hydrophobic portion having 10 or more carbon atoms, and has a density of 200 to 1,000 kg/m³.

The urethane resin (A) can be, for example, dispersed in the below-mentioned water (B), and there can be used, for example, a urethane resin having a hydrophilic group, such as an anionic group, a cationic group, or a nonionic group; or a urethane resin forcibly dispersed in the water (B) using an emulsifying agent. These urethane resins (A) may be used individually or in combination. Among these, in view of the production stability, a urethane resin having a hydrophilic group is preferably used, and an aqueous urethane resin having an anionic group is more preferred.

As a method for obtaining the urethane resin having an anionic group, for example, there can be mentioned a method using at least one compound selected from the group consisting of a glycol compound having a carboxyl group and a compound having a sulfonyl group as a raw material.

As the glycol compound having a carboxyl group, for example, 2,2-dimethylolpropionic acid, 2,2-dimethylolbutanoic acid, 2,2-dimethylolbutyric acid, 2,2-dimethylolpropionic acid, or 2,2-valeric acid can be used. These compounds may be used individually or in combination.

As the compound having a sulfonyl group, for example, 3,4-diaminobutanesulfonic acid, 3,6-diamino-2-toluenesulfonic acid, 2,6-diaminobenzenesulfonic acid, or N-(2-aminoethyl)-2-aminoethylsulfonic acid can be used. These compounds may be used individually or in combination.

From the viewpoint of achieving still further excellent water dispersion stability, the amount of the raw materials used for producing the urethane resin having an anionic group is preferably in the range of 0.1 to 4.8% by mass, more preferably in the range of 0.5 to 4% by mass, further preferably in the range of 1 to 3% by mass, based on the total mass of the raw materials of the urethane resin (A).

A part of or all of the carboxyl group and sulfonyl group may be neutralized by a basic compound in the urethane resin composition. As the basic compound, for example, there can be used ammonia; an organic amine, such as triethylamine, pyridine, or morpholine; an alkanolamine, such as monoethanolamine or dimethylethanolamine; or a metal basic compound containing sodium, potassium, lithium, calcium, or the like.

As a method for obtaining the urethane resin having a cationic group, for example, there can be mentioned a method using one or two or more compounds having an amino group as a raw material.

As the compound having an amino group, for example, there can be used a compound having a primary or secondary amino group, such as triethylenetetramine or diethylenetriamine; or a compound having a tertiary amino group, e.g., an N-alkyldialkanolamine, such as N-methyldiethanolamine or N-ethyldiethanolamine, or an N-alkyldiaminoalkylamine, such as N-methyldiaminoethylamine or N-ethyldiaminoethylamine. These compounds may be used individually or in combination.

As the urethane resin (A), specifically, for example, there can be used a reaction product of a polyisocyanate (a1), a polyol (a2), and the raw materials used for producing the above-mentioned aqueous urethane resin having a hydrophilic group.

As the polyisocyanate (a1), for example, there can be used an aromatic polyisocyanate, such as phenylene diisocyanate, toluene diisocyanate, diphenylmethane diisocyanate, xylylene diisocyanate, naphthalene diisocyanate, polymethylene polyphenyl polyisocyanate, or carbodiimidated diphenylmethane polyisocyanate; or an aliphatic or alicyclic polyisocyanate, such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, dimer acid diisocyanate, or norbornene diisocyanate. These polyisocyanates may be used individually or in combination.

From the viewpoint of the production stability and mechanical physical properties of the obtained film, the amount of the polyisocyanate (a1) used is preferably in the range of 5 to 40% by mass, more preferably in the range of 10 to 30% by mass, based on the total mass of the raw materials of the urethane resin (A).

As the polyol (a2), for example, there can be used a polyether polyol, a polyester polyol, a polyacrylic polyol, a polycarbonate polyol, a polybutadiene polyol, or the like. These polyols may be used individually or in combination.

From the viewpoint of the mechanical strength of the obtained film, the polyol (a2) preferably has a number average molecular weight in the range of 500 to 8,000, more preferably in the range of 800 to 4,000. The number average molecular weight of the polyol (a2) indicates a value as measured by a gel permeation column chromatography (GPC) method.

The polyol (a2) and a chain extender (a2′) having a number average molecular weight of 50 to 450 may be used in combination if necessary. As the chain extender (a2′), for example, there can be used a chain extender having a hydroxyl group, such as ethylene glycol, diethylene glycol, triethylene glycol, propylene glycol, dipropylene glycol, 1,3-propanediol, 1,3-butanediol, 1,4-butanediol, hexamethylene glycol, saccharose, methylene glycol, glycerol, sorbitol, bisphenol A, 4,4′-dihydroxydiphenyl, 4,4′-dihydroxydiphenyl ether, or trimethylolpropane; or a chain extender having an amino group, such as ethylenediamine, 1,2-propanediamine, 1,6-hexamethylenediamine, piperazine, 2,5-dimethylpiperazine, isophoronediamine, 1,2-cyclohexanediamine, 1,3-cyclohexanediamine, 1,4-cyclohexanediamine, 4,4′-dicyclohexylmethanediamine, 3,3′-dimethyl-4,4′-dicyclohexylmethanediamine, 1,4-cyclohexanediamine, or hydrazine. These chain extenders may be used individually or in combination.

When the chain extender (a2′) is used, from the viewpoint of easily controlling the flow starting temperature of the obtained urethane resin (A) and achieving still further excellent tensile strength, the amount of the chain extender (a2′) used is preferably in the range of 0.8 to 4.3% by mass, more preferably in the range of 1 to 3.5% by mass, further preferably in the range of 1.5 to 3.2% by mass, based on the total mass of the raw materials of the urethane resin (A).

As a method for producing the urethane resin (A), for example, there can be mentioned a method in which all the polyol (a2), the raw materials used for producing the urethane resin having a hydrophilic group, the chain extender (a2′), and the polyisocyanate (a1) are charged and subjected to reaction. The reaction in the above method can be conducted, for example, at 50 to 100° C. for 3 to 10 hours.

In producing the urethane resin (A), the molar ratio of the isocyanate group of the polyisocyanate (a1) to the total of the hydroxyl group of the polyol (a2), the hydroxyl group and amino group of the raw materials used for producing the urethane resin having a hydrophilic group, and the hydroxyl group and amino group of the chain extender (a2′) [isocyanate group/(hydroxyl group and amino group)] is preferably in the range of 0.8 to 1.2, more preferably in the range of 0.9 to 1.1.

In producing the urethane resin (A), it is preferred that the isocyanate group remaining in the urethane resin (A) is deactivated. When deactivating the isocyanate group, an alcohol having one hydroxyl group, such as methanol, is preferably used. The amount of the alcohol used is preferably in the range of 0.001 to 10 parts by mass, relative to 100 parts by mass of the urethane resin (A).

Further, when producing the urethane resin (A), an organic solvent may be used. As the organic solvent, for example, there can be used a ketone compound, such as acetone or methyl ethyl ketone; an ether compound, such as tetrahydrofuran or dioxane; an acetate compound, such as ethyl acetate or butyl acetate; a nitrile compound, such as acetonitrile; or an amide compound, such as dimethylformamide or N-methylpyrrolidone. These organic solvents may be used individually or in combination. It is preferred that the organic solvent is removed by a distillation method or the like when obtaining the final urethane resin composition.

From the viewpoint of stably retaining the foam (particularly in the drying step) generated in the below-mentioned foaming step so as to stably obtain a foamed urethane sheet having a density in the range of 200 to 1,000 kg/m³, the flow starting temperature of the urethane resin (A) is preferably 80° C. or higher, more preferably in the range of 80 to 220° C.

As a method for controlling the flow starting temperature of the urethane resin (A), there can be mentioned a method of controlling the flow starting temperature by mainly the type of the polyol (a2) which is the raw material of the below-mentioned urethane resin (A), the amount of the chain extender (a2′) used, and the type of the polyisocyanate (a1). As a method of controlling the flow starting temperature to be higher, for example, there can be mentioned the use of a highly crystalline polyol, such as polycarbonate polyol, as the polyol (a2), an increase of the amount of the chain extender (a2′) used, and the use of a highly crystalline polyisocyanate, such as dicyclohexylmethane diisocyanate or 4,4′-diphenylmethane diisocyanate, as the polyisocyanate (a1). Further, as a method of controlling the flow starting temperature to be lower, for example, there can be mentioned the use of a poorly crystalline polyol, such as polyoxypropylene glycol, as the polyol (a2), a reduction of the amount of the chain extender (a2′) used, and the use of a poorly crystalline polyisocyanate, such as isophorone diisocyanate or toluene diisocyanate, as the polyisocyanate (a1). Accordingly, the flow starting temperature of the urethane resin (A) can be controlled by appropriately selecting a method from these methods. A method for measuring the flow starting temperature of the urethane resin (A) is described in the Examples shown below.

When a urethane resin having an anionic group is used as the urethane resin (A), from the viewpoint of easily controlling the flow starting temperature and achieving still further excellent retention of foam, texture, and tensile strength, it is preferred to use a urethane resin (A-A-1) having an anionic group which is a reaction product of at least one polyisocyanate selected from the group consisting of 4,4′-diphenylmethane diisocyanate, toluene diisocyanate, cyclohexylmethane diisocyanate, and isophorone diisocyanate, the polyol (a2), a glycol compound having a carboxyl group, and a chain extender containing the chain extender (a2′) having a hydroxyl group.

As the water (B), for example, ion-exchanged water or distilled water can be used. These waters may be used individually or in combination.

From the viewpoint of the water dispersion stability and working properties, the mass ratio of the urethane resin (A) to the water (B) [(A)/(B)] is preferably in the range of 10/80 to 70/30, more preferably in the range of 20/80 to 60/40.

With respect to the surfactant (C), for preventing the foam formed by foaming from disappearing, it is necessary that the surfactant (C) having no aromatic ring and having a hydrophobic portion having 10 or more carbon atoms is used.

As the surfactant (C), for example, a surfactant represented by the general formula (1) below; a fatty acid salt, a succinic acid salt, a sulfosuccinic acid salt, an octadecylsulfosuccinic acid salt, a sulfosuccinic acid ester, or the like can be used. These surfactants may be used individually or in combination.

RCO₂⁻x⁺ (1)

In the formula (1), R represents an alkyl group having a linear or branched structure having 10 to 20 carbon atoms, and X represents Na, K, NH₄, morpholine, ethanolamine, or triethanolamine.

With respect to the surfactant (C), among those mentioned above, the surfactant represented by the general formula (1) above is preferably used because it has still further excellent retention of foam, and the surfactant having a linear alkyl group having 13 to 19 carbon atoms is more preferably used, and a stearic acid salt is further preferred.

From the viewpoint of obtaining still further excellent retention of foam, the amount of the surfactant (C) used is preferably in the range of 0.01 to 10 parts by mass, more preferably in the range of 0.1 to 5 parts by mass, relative to 100 parts by mass of the urethane resin (A) (=solids).

The urethane resin composition contains the above-mentioned urethane resin (A), water (B), and surfactant (C) as essential components, but may contain an additional additive if necessary.

With respect to the additional additive, for example, there can be used a crosslinking agent, a neutralizing agent, a thickener, a urethane-forming reaction catalyst, a filler, a pigment, a dye, a flame retardant, a leveling agent, an anti-blocking agent, and the like. These additives may be used individually or in combination.

The crosslinking agent is used for the purpose of improving the mechanical strength of the foamed urethane sheet and the like, and, for example, there can be used a polyisocyanate crosslinking agent, an epoxy crosslinking agent, a melamine crosslinking agent, or an oxazoline crosslinking agent. These crosslinking agents may be used individually or in combination. When using the crosslinking agent, the amount of the crosslinking agent used, for example, relative to 100 parts by mass of the urethane resin (A) (=solids), is preferably in the range of 0.01 to 100 parts by mass, more preferably in the range of 0.1 to 50 parts by mass, further preferably in the range of 0.5 to 30 parts by mass, especially preferably 1 to 10 parts by mass.

Next, a method for producing the foamed urethane sheet of the invention is described.

The foamed urethane sheet is produced by foaming the urethane resin composition to obtain a foamed liquid, and applying the obtained foamed liquid to a substrate, and drying the applied liquid so as to have a density of 200 to 1,000 kg/m³.

As a method for foaming the urethane resin composition to obtain a foamed liquid, for example, there can be mentioned a method in which the urethane resin composition is manually stirred, and a method in which the urethane resin composition is stirred using a mixer, such as a mechanical mixer. As a method using a mixer, for example, there can be mentioned a method in which the urethane resin composition is stirred at 500 to 3,000 rpm for 10 seconds to 3 minutes. In this case, in view of easily controlling the density of the foamed urethane sheet to be in the range defined in the invention, the foamed liquid obtained after foaming preferably has a volume 1.3 to 7 times, more preferably 1.2 to 2 times, further preferably 1.3 to 1.7 times the volume of the urethane resin composition before foaming.

As a method for applying the obtained foamed liquid to a substrate, such as release paper, for example, there can be mentioned a method using a roll coater, a knife coater, a comma coater, an applicator, or the like.

As a method for drying the applied material, for example, there can be mentioned a method in which the applied material is dried at a temperature of 60 to 130° C. for 30 seconds to 10 minutes.

The foamed urethane sheet obtained by the above-mentioned method has a thickness of, for example, 5 to 200 μm.

It is necessary that the foamed urethane sheet has a density of 200 to 1,000 kg/m³. When the density is in this range, a sheet having both excellent texture and excellent tensile strength is obtained. From the viewpoint of the applicability of the foamed urethane sheet to various uses, the density of the foamed urethane sheet is preferably in the range of 300 to 900 kg/m³, more preferably in the range of 400 to 800 kg/m³. The density of the foamed urethane sheet indicates a value determined by dividing the mass of the foamed urethane sheet by the volume of the sheet.

Next, the synthetic leather of the invention is described.

The synthetic leather of the invention is a synthetic leather having at least a substrate (i) and a polyurethane layer (ii), wherein the polyurethane layer (ii) is formed from the above-mentioned foamed urethane sheet.

As a method for producing the synthetic leather, for example, there can be mentioned:

(X) a method in which the urethane resin composition is foamed to obtain a foamed liquid, and the obtained foamed liquid is applied onto release paper, and dried, and bonded to the above-mentioned substrate (i),

(Y) a method in which the urethane resin composition is foamed to obtain a foamed liquid, and the obtained foamed liquid is applied onto a skin layer formed on release paper, and dried, and bonded to the substrate (i), and

(Z) a method in which the urethane resin composition is foamed to obtain a foamed liquid, and the obtained foamed liquid is applied onto the substrate (i), and dried, and, if necessary, a skin layer (iii) formed on release paper is bonded onto the resultant substrate.

As the substrate (i), for example, there can be used a fiber substrate, such as nonwoven fabric, woven fabric, or knitted fabric, each formed from a polyester fiber, a polyethylene fiber, a nylon fiber, an acrylic fiber, a polyurethane fiber, an acetate fiber, a rayon fiber, a polylactate fiber, cotton, linen, silk, wool, a glass fiber, a carbon fiber, a mixed fiber thereof, or the like; the above-mentioned nonwoven fabric which is impregnated with a resin, such as a polyurethane resin; the above-mentioned nonwoven fabric which has further formed thereon a porous layer; a resin substrate, such as a thermoplastic urethane (TPU), or the like.

The polyurethane layer (ii) is formed from the above-mentioned foamed sheet, and, in view of obtaining a synthetic leather having both still further excellent texture and peel strength, the polyurethane layer (ii) preferably has a density in the range of 300 to 900 kg/m³, more preferably in the range of 400 to 800 kg/m³. The density of the polyurethane layer (ii) indicates a value determined by dividing a value, which is obtained by subtracting the weight of the substrate (i) 10 cm square from the weight of the synthetic leather 10 cm square, by the thickness of the polyurethane layer (ii). The density of the polyurethane layer (ii) can be controlled by appropriately foaming the urethane resin composition.

The skin layer (iii) can be formed by a known method from a known material, and, for example, a solvent urethane resin, an aqueous urethane resin, a silicone resin, a polypropylene resin, a polyester resin, or the like can be used. In the case of particularly achieving soft texture and excellent heat resistance and hydrolytic resistance, a polycarbonate urethane resin is preferably used. Further, for reducing the use of DMF to protect the environment, an aqueous polycarbonate urethane resin is more preferably used.

On the skin layer (iii), if necessary, a surface treatment layer (iv) may be formed for the purpose of improving the marring resistance and the like. The surface treatment layer (iv) can be formed by a known method from a known material.

As apparent from the above, by virtue of using the above-mentioned foamed urethane sheet having excellent texture and tensile strength, the synthetic leather of the invention is advantageous not only in that it further has excellent peel strength, but also in that embossing having excellent design properties can be uniformly formed on the surface of the synthetic leather.

As a method for embossing the polyurethane layer (ii), for example, there can be mentioned a method in which release paper having formed thereon a design, such as an uneven pattern, is placed on the polyurethane layer (ii) of the synthetic leather, and subjected to hot pressing by a preheated roll or the like; and a method in which the polyurethane layer (ii) of the synthetic leather is subjected to hot pressing using a roll coater having formed thereon a design, such as an uneven pattern. In the hot pressing, a roll can be heated, for example, at 50 to 200° C.

### EXAMPLES

Hereinbelow, the present invention will be described in more detail with reference to the following Examples.

### [Synthesis Example 1] Preparation of Urethane Resin (A-1)

1,000 Parts by mass of polycarbonate polyol (“NIPPOLAN 980R”, manufactured by Nippon Polyurethane Industry Co., Ltd.; number average molecular weight: 2,000), 17 parts by mass of 2,2-dimethylolpropionic acid, 47 parts by mass of ethylene glycol, and 344 parts by mass of diphenylmethane diisocyanate (hereinafter, abbreviated to “MDI”) were subjected to reaction at 70° C. in the presence of 3,281 parts by mass of methyl ethyl ketone and 0.1 part by mass of tin (II) octylate until the solution viscosity reached 20,000 mPa·s, and then 3 parts by mass of methanol was added to terminate the reaction, obtaining a methyl ethyl ketone solution of a urethane resin. Into the obtained urethane resin solution were mixed 70 parts by mass of polyoxyethylene distyrenated phenyl ether (Hydrophile-Lipophile Balance (hereinafter, abbreviated to “HLB”): 14) and 13 parts by mass of triethylamine, and then 800 parts by mass of ion-exchanged water was added to the resultant mixture to cause phase reversal of emulsion, obtaining an emulsion having the urethane resin (A-1) dispersed in water.

Then, methyl ethyl ketone was distilled off from the emulsion to obtain a urethane resin composition containing the urethane resin (A-1) in an amount of 50% by mass.

### [Synthesis Example 2] Preparation of Urethane Resin (A-2)

1,000 Parts by mass of polyether polyol (“PTMG 2000”, manufactured by Mitsubishi Chemical Corporation; number average molecular weight: 2,000), 17 parts by mass of 2,2-dimethylolpropionic acid, 47 parts by mass of ethylene glycol, and 344 parts by mass of MDI were subjected to reaction at 70° C. in the presence of 3,281 parts by mass of methyl ethyl ketone and 0.1 part by mass of tin (II) octylate until the solution viscosity reached 20,000 mPa·s, and then 3 parts by mass of methanol was added to terminate the reaction, obtaining a methyl ethyl ketone solution of a urethane resin. Into the obtained urethane resin solution were mixed 70 parts by mass of polyoxyethylene distyrenated phenyl ether (HLB: 14) and 13 parts by mass of triethylamine, and then 800 parts by mass of ion-exchanged water was added to the resultant mixture to cause phase reversal of emulsion, obtaining an emulsion having the urethane resin (A-2) dispersed in water.

Then, methyl ethyl ketone was distilled off from the emulsion to obtain a urethane resin composition containing the urethane resin (A-2) in an amount of 50% by mass.

### [Synthesis Example 3] Preparation of Urethane Resin (A-3)

1,000 Parts by mass of polyester polyol (“Placcel 220”, manufactured by Daicel Corporation; number average molecular weight: 2,000), 17 parts by mass of 2,2-dimethylolpropionic acid, 47 parts by mass of ethylene glycol, and 344 parts by mass of MDI were subjected to reaction at 70° C. in the presence of 3,281 parts by mass of methyl ethyl ketone and 0.1 part by mass of tin(II) octylate until the solution viscosity reached 20,000 mPa·s, and then 3 parts by mass of methanol was added to terminate the reaction, obtaining a methyl ethyl ketone solution of a urethane resin. Into the obtained urethane resin solution were mixed 70 parts by mass of polyoxyethylene distyrenated phenyl ether (HLB: 14) and 13 parts by mass of triethylamine, and then 800 parts by mass of ion-exchanged water was added to the resultant mixture to cause phase reversal of emulsion, obtaining an emulsion having the urethane resin (A-3) dispersed in water.

Then, methyl ethyl ketone was distilled off from the emulsion to obtain a urethane resin composition containing the urethane resin (A-3) in an amount of 50% by mass.

### [Synthesis Example 4] Preparation of Urethane Resin (A-4)

1,000 Parts by mass of polycarbonate polyol (“NIPPOLAN 980R”, manufactured by Nippon Polyurethane Industry Co., Ltd.; number average molecular weight: 2,000), 17 parts by mass of 2,2-dimethylolpropionic acid, and 262 parts by mass of dicyclohexylmethane diisocyanate (hereinafter, abbreviated to “H12MDI”) were subjected to reaction at 70° C. in the presence of 1,279 parts by mass of methyl ethyl ketone and 0.1 part by mass of tin(II) octylate until the isocyanate concentration reached 1.2% by mass, obtaining a methyl ethyl ketone solution of a urethane prepolymer. Into the obtained urethane resin solution were mixed 64 parts by mass of polyoxyethylene distyrenated phenyl ether (Hydrophile-Lipophile Balance (hereinafter, abbreviated to “HLB”): 14) and 28 parts by mass of triethylamine, and then 2,650 parts by mass of ion-exchanged water was added to the resultant mixture to cause phase reversal of emulsion, obtaining an emulsion having the urethane prepolymer dispersed in water. Into the obtained emulsion were mixed 21 parts by mass of ethylenediamine and 189 parts of ion-exchanged water to cause a chain extension reaction, obtaining a urethane resin composition.

Then, methyl ethyl ketone and water were distilled off from the urethane resin composition to obtain a urethane resin composition containing the urethane resin (A-4) in an amount of 50% by mass.

### [Synthesis Example 5] Preparation of Urethane Resin (A-5)

1,000 Parts by mass of polyether polyol (“PTMG 2000”, manufactured by Mitsubishi Chemical Corporation; number average molecular weight: 2,000), 17 parts by mass of 2,2-dimethylolpropionic acid, and 262 parts by mass of H12MDI were subjected to reaction at 70° C. in the presence of 1,279 parts by mass of methyl ethyl ketone and 0.1 part by mass of tin(II) octylate until the isocyanate concentration reached 1.2% by mass, obtaining a methyl ethyl ketone solution of a urethane resin prepolymer (A′-2). Into the obtained urethane resin solution were mixed 64 parts by mass of polyoxyethylene distyrenated phenyl ether (Hydrophile-Lipophile Balance (hereinafter, abbreviated to “HLB”): 14) and 28 parts by mass of triethylamine, and then 2,650 parts by mass of ion-exchanged water was added to the resultant mixture to cause phase reversal of emulsion, obtaining an emulsion having the urethane prepolymer dispersed in water. Into the obtained emulsion were mixed 21 parts by mass of ethylenediamine and 189 parts of ion-exchanged water to cause a chain extension reaction, obtaining a urethane resin composition.

Then, methyl ethyl ketone and water were distilled off from the urethane resin composition to obtain a urethane resin composition containing the urethane resin (A-5) in an amount of 50% by mass.

### [Synthesis Example 6] Preparation of Urethane Resin (A-6)

1,000 Parts by mass of polyester polyol (“Placcel 220”, manufactured by Daicel Corporation; number average molecular weight: 2,000), 17 parts by mass of 2,2-dimethylolpropionic acid, and 262 parts by mass of H12MDI were subjected to reaction at 70° C. in the presence of 1, 279 parts by mass of methyl ethyl ketone and 0.1 part by mass of tin(II) octylate until the isocyanate concentration reached 1.2% by mass, obtaining a methyl ethyl ketone solution of a urethane resin prepolymer. Into the obtained urethane resin solution were mixed 64 parts by mass of polyoxyethylene distyrenated phenyl ether (Hydrophile-Lipophile Balance (hereinafter, abbreviated to “HLB”): 14) and 28 parts by mass of triethylamine, and then 2,650 parts by mass of ion-exchanged water was added to the resultant mixture to cause phase reversal of emulsion, obtaining an emulsion having the urethane prepolymer dispersed in water. Into the obtained emulsion were mixed 21 parts by mass of ethylenediamine and 189 parts of ion-exchanged water to cause a chain extension reaction, obtaining a urethane resin composition.

Then, methyl ethyl ketone and water were distilled off from the urethane resin composition to obtain a urethane resin composition containing the urethane resin (A-6) in an amount of 50% by mass.

### Example 1

To 100 parts by mass of the urethane resin composition obtained in Synthesis Example 1 were added 2 parts by mass of a thickener (“Borchi Gel ALA”, manufactured by Borchers GmbH), 0.5 part by mass of ammonium stearate, and 4 parts by mass of a crosslinking agent (“EPOCROS WS-700”, manufactured by Nippon Shokubai Co., Ltd.), and the resultant mixture was foamed by stirring using a mechanical mixer at 2,000 rpm for one minute to obtain a foamed liquid having a volume 1.5 times the original volume.

The obtained foamed liquid was applied to release paper, and dried at 80° C. for 3 minutes and further at 120° C. for 2 minutes to produce a foamed urethane sheet.

### Examples 2 to 8

Foamed urethane sheets were individually obtained in the same manner as in Example 1 except that the type of the aqueous urethane resin composition used and the amount of the ammonium stearate used were changed as shown in Tables 1 to 3.

### Comparative Example 1

To 100 parts by mass of the urethane resin composition obtained in Synthesis Example 1 were added 2 parts by mass of a thickener (“Borchi Gel ALA”, manufactured by Borchers GmbH), 1.5 parts by mass of sodium dodecylbenzenesulfonate, and 4 parts by mass of a crosslinking agent (“EPOCROS WS-700”, manufactured by Nippon Shokubai Co., Ltd.), and the resultant mixture was foamed by stirring using a mechanical mixer at 2,000 rpm for one minute to obtain a foamed liquid having a volume 1.5 times the original volume.

The obtained foamed liquid was applied to release paper, and dried at 80° C. for 3 minutes and further at 120° C. for 2 minutes to produce a sheet.

### Comparative Example 2

To 100 parts by mass of the urethane resin composition obtained in Synthesis Example 1 were added 2 parts by mass of a thickener (“Borchi Gel ALA”, manufactured by Borchers GmbH) and 4 parts by mass of a crosslinking agent (“EPOCROS WS-700”, manufactured by Nippon Shokubai Co., Ltd.), and the resultant mixture was foamed by stirring using a mechanical mixer at 2,000 rpm for one minute to obtain a foamed liquid having a volume 1.5 times the original volume.

The obtained foamed liquid was applied to release paper, and dried at 80° C. for 3 minutes and further at 120° C. for 2 minutes, and the foam disappeared in the drying step, and thus a sheet having almost no pore was formed.

### Comparative Example 3

To 100 parts by mass of the urethane resin composition obtained in Synthesis Example 1 were added 2 parts by mass of a thickener (“Borchi Gel ALA”, manufactured by Borchers GmbH), 1.5 parts by mass of sodium dodecylbenzenesulfonate, 1 part by mass of ammonium stearate, and 4 parts by mass of a crosslinking agent (“EPOCROS WS-700”, manufactured by Nippon Shokubai Co., Ltd.), and the resultant mixture was foamed by stirring using a mechanical mixer at 2,000 rpm for one minute to obtain a foamed liquid having a volume 7 times the original volume.

The obtained foamed liquid was applied to release paper, and dried at 80° C. for 3 minutes and further at 120° C. for 2 minutes to produce a sheet.

### [Method for Measuring a Number Average Molecular Weight]

The number average molecular weight of the polyol and the like used in the Synthesis Examples was measured by a gel permeation column chromatography (GPC) method under the conditions shown below.

Measuring apparatus: High-speed GPC apparatus (“HLC-8220GPC”, manufactured by Tosoh Corp.)
Columns: The columns shown below, manufactured by Tosoh Corp., which are connected in series were used.

“TSKgel G5000” (7.8 mm I.D.×30 cm)×1

“TSKgel G4000” (7.8 mm I.D.×30 cm)×1

“TSKgel G3000” (7.8 mm I.D.×30 cm)×1

“TSKgel G2000” (7.8 mm I.D.×30 cm)×1

Detector: RI (differential refractometer)
Column temperature: 40° C.

### Eluent: Tetrahydrofuran (THF)

Flow rate: 1.0 mL/minute
Sample amount per injection: 100 μL (tetrahydrofuran solution having a sample concentration of 0.4% by mass) Standard sample: A calibration curve was prepared using the standard polystyrenes shown below.

### (Standard Polystyrenes)

“TSKgel standard polystyrene A-500”, manufactured by Tosoh Corp.

“TSKgel standard polystyrene A-1000”, manufactured by Tosoh Corp.

“TSKgel standard polystyrene A-2500”, manufactured by Tosoh Corp.

“TSKgel standard polystyrene A-5000”, manufactured by Tosoh Corp.

“TSKgel standard polystyrene F-1”, manufactured by Tosoh Corp.

“TSKgel standard polystyrene F-2”, manufactured by Tosoh Corp.

“TSKgel standard polystyrene F-4”, manufactured by Tosoh Corp.

“TSKgel standard polystyrene F-10”, manufactured by Tosoh Corp.

“TSKgel standard polystyrene F-20”, manufactured by Tosoh Corp.

“TSKgel standard polystyrene F-40”, manufactured by Tosoh Corp.

“TSKgel standard polystyrene F-80”, manufactured by Tosoh Corp.

“TSKgel standard polystyrene F-128”, manufactured by Tosoh Corp.

“TSKgel standard polystyrene F-288”, manufactured by Tosoh Corp.

“TSKgel standard polystyrene F-550”, manufactured by Tosoh Corp.

### [Method for Measuring a Flow Starting Temperature of Urethane Resin (A)]

The aqueous urethane resin composition obtained in the Synthesis Example was applied to release paper (thickness of the applied composition: 150 μm), and dried by means of a hot-air dryer at 70° C. for 4 minutes and further at 120° C. for 2 minutes to obtain a dried material. With respect to the obtained dried material, a flow starting temperature was measured using Flow Tester “CFT-500A”, manufactured by Shimadzu Corporation (using a dice having a bore diameter of 1 mm and a length of 1 mm; load: 98 N; temperature increase rate: 3° C./minute).

### [Evaluation Method for Texture]

The obtained foamed urethane sheet was touched by hands, and evaluated according to the following criteria.

“A”: Excellent flexibility.

“B”: Slight flexibility.

“C”: Poor flexibility.

“D”: Hard.

### [Method for Measuring a Tensile Strength]

The obtained urethane sheet was cut into a piece having a width of 10 mm and a length of 60 mm and the resultant piece was used as a test specimen. The test specimen was fixed at both ends by a chuck, and pulled using a tensile tester “Autograph AG-I” (manufactured by Shimadzu Corporation) at a crosshead speed of 300 mm/minute in an atmosphere at a temperature of 23° C. and at a humidity of 60% to measure a tensile strength at 100% elongation, and the measured tensile strength was evaluated according to the following criteria.

“T”: 10 N/cm² or more

“F”: Less than 10 N/cm²

TABLE 1

| Table 1 | Example 1 | Example 2 | Example 3 | Example 4 |
|---|---|---|---|---|
| Urethane resin (A) | (A-1) | (A-2) | (A-3) | (A-1) |
| Aromatic polyisocyanate (a1) | MDI | MDI | MDI | MDI |
| Flow starting temperature (° C.) | 160 | 160 | 160 | 160 |
| Surfactant (C) | Ammonium | Ammonium | Ammonium | Ammonium |
| | stearate | stearate | stearate | stearate |
| Amount of (C) used (relative to | 1.0 | 1 | 1 | 3.5 |
| 100 parts by mass of urethane | | | | |
| resin (A) (solids)) | | | | |
| Density of foamed urethane | 660 | 670 | 660 | 680 |
| sheet (kg/m³) | | | | |
| Evaluation of texture | A | A | A | A |
| Evaluation of tensile strength | T | T | T | T |

TABLE 2

| Table 2 | Example 5 | Example 6 | Example 7 | Example 8 |
|---|---|---|---|---|
| Urethane resin (A) | (A-4) | (A-5) | (A-6) | (A-4) |
| Aromatic polyisocyanate (a1) | H12MDI | H12MDI | H12MDI | H12MDI |
| Flow starting temperature (° C.) | 160 | 160 | 160 | 160 |
| Surfactant (C) | Ammonium | Ammonium | Ammonium | Ammonium |
| | stearate | stearate | stearate | stearate |
| Amount of (C) used (relative to | 1.0 | 1.0 | 1.0 | 3.5 |
| 100 parts by mass of urethane | | | | |
| resin (A) (solids)) | | | | |
| Density of foamed urethane | 660 | 680 | 670 | 680 |
| sheet (kg/m³) | | | | |
| Evaluation of texture | A | A | A | A |
| Evaluation of tensile strength | T | T | T | T |

TABLE 3

| | Comparative | Comparative | Comparative |
|---|---|---|---|
| Table 3 | Example 1 | Example 2 | Example 3 |
| Urethane resin (A) | (A-1) | (A-1) | (A-1) |
| Aromatic polyisocyanate (a1) | MDI | MDI | MDI |
| Flow starting temperature (° C.) | 160 | 160 | 160 |
| Surfactant (C) | Sodium | | Ammonium |
| | dodecylbenzene-sulfonate | | stearate |
| Amount of (C) used (relative to | 1 | 0 | 1 |
| 100 parts by mass of urethane | | | |
| resin (A) (solids)) | | | |
| Density of foamed urethane | 990 | 1010 | 150 |
| sheet (kg/m³) | | | |
| Evaluation of texture | D | D | A |
| Evaluation of tensile strength | T | T | F |

It was found that the foamed urethane sheet of the present invention in Examples 1 to 8 has excellent texture and tensile strength.

On the other hand, in Comparative Example 1 which corresponds to an embodiment in which sodium dodecylbenzenesulfonate which has an aromatic ring was used instead of the surfactant (C), the retention of foam was poor, and the texture of the sheet was hard and poor.

In Comparative Example 2 which corresponds to an embodiment in which the surfactant (C) was not used, the retention of foam was poor, and the texture of the sheet was hard and poor.

In Comparative Example 3 which corresponds to an embodiment in which the foaming ratio is too large and the density is less than the range defined in the invention, the tensile strength was low.

### Example 9

To 100 parts by mass of the urethane resin composition obtained in Synthesis Example 1 were added 2 parts by mass of a thickener (“Borch Gel ALA”, manufactured by Borchers GmbH), 1.5 parts by mass of ammonium stearate, and 4 parts by mass of a crosslinking agent (“EPOCROS WS-700”, manufactured by Nippon Shokubai Co., Ltd.), and the resultant mixture was foamed by stirring using a mechanical mixer at 2,000 rpm for one minute to obtain a foamed liquid having a volume 1.5 times the original volume.

The obtained foamed liquid was applied to polyester fiber nonwoven fabric, and dried at 80° C. for 3 minutes and further at 120° C. for 2 minutes to form a polyurethane layer. Then, release paper having an uneven pattern formed thereon was placed on the obtained polyurethane layer, and subjected to pressing by a roll preheated at 180° C. to obtain an embossed synthetic leather.

### Examples 10 to 12

Synthetic leathers were individually obtained in the same manner as in Example 9 except that the type of the urethane resin composition used and the amount of the ammonium stearate used were changed as shown in Table 4.

### [Evaluation Method for Texture]

The obtained synthetic leather was touched by hands, and evaluated according to the following criteria.

“A”: Excellent flexibility.

“B”: Slight flexibility.

“C”: Poor flexibility.

“D”: Hard.

### [Method for Measuring a Peel Strength]

With respect to the synthetic leathers obtained in the Examples and Comparative Examples, a peel strength was measured using Shimadzu Autograph “AG-1” (manufactured by Shimadzu Corporation) under conditions at a full scale of 5 kg and at a head speed of 20 mm/minute, and evaluated according to the following criteria.

“A”: 0.15 MPa or more

“B”: 0.1 to less than 0.15 MPa

“C”: Less than 0.1 MPa

### [Evaluation Method for Embossing Characteristics]

The synthetic leathers obtained in the Examples and Comparative Examples were individually visually observed, and evaluated according to the following criteria.

“T”: Wrinkles formed on the surface by embossing are uniform.

“F”: Wrinkles formed on the surface by embossing are not uniform.

TABLE 4

| Table 4 | Example 9 | Example 10 | Example 11 | Example 12 |
|---|---|---|---|---|
| Urethane resin (A) | (A-1) | (A-2) | (A-3) | (A-4) |
| Aromatic polyisocyanate (a1) | MDI | MDI | MDI | H12MDI |
| Flow starting temperature (° C.) | 160 | 160 | 160 | 160 |
| Surfactant (C) | Ammonium | Ammonium | Ammonium | Ammonium |
| | stearate | stearate | stearate | stearate |
| Amount of (C) used (relative to | 1 | 1 | 1 | 3.5 |
| 100 parts by mass of urethane | | | | |
| resin (A)) | | | | |
| Density of polyurethane | 690 | 680 | 690 | 680 |
| layer (ii) (kg/m³) | | | | |
| Evaluation of texture | A | A | A | A |
| Evaluation of peel strength | A | A | A | A |
| Evaluation of embossing | T | T | T | T |
| characteristics | | | | |

It was found that the synthetic leather of the present invention in Examples 9 to 12 has excellent texture, peel strength, and embossing characteristics.

1. A foamed urethane sheet, which is formed from a urethane resin composition containing a urethane resin (A), water (B), and a surfactant (C) having no aromatic ring and having a hydrophobic portion having 10 or more carbon atoms, and has a density of 200 to 1,000 kg/m³.

2. The foamed urethane sheet according to claim 1, wherein the surfactant (C) is a stearic acid salt.

3. The foamed urethane sheet according to claim 1, wherein the urethane resin (A) has an anionic group.

4. The foamed urethane sheet according to claim 1, wherein the urethane resin (A) has a flow starting temperature of 80° C. or higher.

5. A synthetic leather having at least a substrate (i) and a polyurethane layer (ii),
wherein the polyurethane layer (ii) is formed from the foamed urethane sheet according to claim 1.

6. The synthetic leather according to claim 5, wherein the polyurethane layer (ii) is embossed.

7. The foamed urethane sheet according to claim 2, wherein the urethane resin (A) has an anionic group.
